(19) United States
(12) Patent Application Publication
(10) Pub. No.: US 2010/0209681 A1
(43) Pub. Date: Aug. 19, 2010

(54) POLYIMIDE FILMS COMPRISING FLUOROPOLYMER COATING AND METHODS

(76) Inventors: Grant Richard Lee, Deer Park, TX (US); Gregory Douglas Clements, Houston, TX (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 12/676,517

(22) PCT Filed: Sep. 5, 2008
(86) PCT No.: PCT/US08/10392

§ 371 Date: Mar. 4, 2010

Related U.S. Application Data
(60) Provisional application No. 60/967,682, filed on Sep. 6, 2007.

(51) Int. Cl. H01B 3/44; H01B 13/22; B32B 27/08; B32B 7/02; H01B 17/60

(52) U.S. Cl. 428/216; 428/422; 428/220; 428/336; 156/53

(57) ABSTRACT

A dielectric composite is provided that is useful for wrapping wire or cable or for supporting electronic circuitry. The composite comprises a polyimide layer having first and second major surfaces; a first fluoropolymer layer on the first major surface on the polyimide layer, said first fluoropolymer layer comprising at least about 55% PFA; and a second fluoropolymer layer on the second major surface on the polyimide layer, said second fluoropolymer layer comprising at least about 55% PFA. Protected wire or cable using the composite, and methods are also described.

### CROSS-REFERENCE TO RELATED APPLICATIONS

This application claims the benefit of U.S. Provisional Application Ser. No. 60/967,682, filed Sep. 6, 2007, entitled “POLYIMIDE FILMS COMPRISING FLUOROPOLYMER COATING AND METHODS” which application is incorporated herein by reference in its entirety.

### FIELD OF THE INVENTION

The present invention relates to a dielectric composite useful for wrapping wire or cable or for supporting electronic circuitry. More specifically, the present invention relates to multilayer dielectric composites useful for providing advantageous electrical insulation protection.

### BACKGROUND OF THE INVENTION

Electro-magnetic energy conductors are conventionally coated with a jacket to protect against catastrophic failures of the electro-magnetic system by short circuit. A number of materials have been used as protective jackets, such as polyvinyl chloride (PVC), polyurethane, polyimide, polytetrafluoroethylene (PTFE), expanded PTFE, fluorinated ethylene propylene, perfluoroalkoxy polymer, polyesters, silicone rubber, and nylon. These materials have been applied over the conductors in a variety of ways, including by extrusion, tape wrap, insertion within pre-formed tubes, shrink wrap, etc. As a specific example, U.S. Pat. No. 5,846,355 describes a jacket material comprising a silicone material that is imbibed into a porous polymer, such as expanded polytetrafluoroethylene, to produce a flexible and durable composite.

Various laminar structures comprising polyimide and a combination of certain fluoropolymer layers have been described for use as an insulating wire or cable wrap. For example, U.S. Pat. No. 3,616,177 discloses a construction comprising at least three layers, including a base polyimide layer, a layer of fluoroethylene propylene (FEP) copolymer and a layer of polytetrafluoroethylene (PTFE) copolymer. This patent further describes a four layer construction having FEP on both sides of the polyimide base layer, with a layer of PTFE on of the FEP layers. See column 1, lines 37-45. An alternative construction is disclosed in U.S. Pat. No. 5,399,434, which describes a tape having a polyimide core layer, inner fluorinated ethylenepropylene copolymer (FEP) layers, intermediate polytetrafluoroethylene homopolymer (PTFE) and fluorinated ethylenepropylene copolymer (FEP) blend layers and outer fluorinated ethylenepropylene copolymer (FEP) layers for use as an insulating wire or cable wrap.

U.S. Pat. No. 7,022,402 describes a film used to wrap electrically conductive materials, particularly for aerospace, high voltage machinery and/or other high performance applications. The film is an asymmetric multi-layer insulative film made by combining a layer of polyimide and a high-temperature bonding layer, the high-temperature bonding layer being derived from a high temperature base polymer made of poly(tetrafluoroethylene-co-perfluoro[alkyl vinyl ether]) (PFA) and optionally blended with from 0 60 weight percent poly(tetrafluoroethylene-co-hexafluoropropylene) (designated “FEP” therein). See the Abstract and the Field of Invention. A high modulus polyimide film is preferred for use as the core layer in order to provide the desired mechanical toughness, though films with a lower modulus may also be used. See column 7, lines 55-62.

A polymeric composite that is a blend of a polyimide component and a fluoropolymer component derived from a micro powder is disclosed to be useful as a wire wrap in U.S. Pat. No. 7,026,032.

### SUMMARY OF THE INVENTION

A dielectric composite is provided that is useful for wrapping wire or cable or for supporting electronic circuitry. The composite comprises a polyimide layer having first and second major surfaces. A first fluoropolymer layer that comprises at least about 55% PFA is on the first major surface on the polyimide layer. A second fluoropolymer layer that comprises at least about 55% PFA is on the second major surface on the polyimide layer.

The dielectric composite as described herein exhibits surprising mechanical abrasion properties. In an embodiment of the present invention, surprising mechanical abrasion properties are particularly observed in a composite wherein the polyimide layer has a modulus that is less than about 650 kpsi. It has been discovered that the selection of fluoropolymer layers on both sides of the construction as comprising at least about 55% PFA affords substantial abrasion resistance properties while also providing excellent electrical insulation properties. This discovery is particularly unexpected in view of the relative thinness of the fluoropolymer layers.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 is a cross sectional side view of an embodiment of the present invention.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

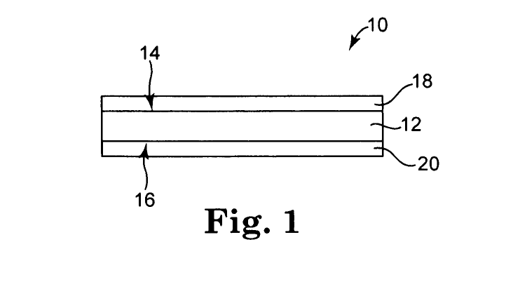

Turning to the drawing, FIG. 1 is a cross sectional side view of an embodiment of the present invention, wherein composite 10 comprises polyimide layer 12 having first major surface 14 and second major surface 16. First fluoropolymer layer 18 is on first major surface 14 of polyimide layer 12. Second fluoropolymer layer 20 is on second major surface 16 of polyimide layer 12. For purposes of orientation, if first fluoropolymer layer 18 has a different chemical constitution from second fluoropolymer layer 20, first fluoropolymer layer 18 is defined as the layer that contacts the metal component of the protected wire or cable construction, or the polyimide to metal (“PTM”) layer. Second fluoropolymer layer 20 is defined as the layer intended to contact additional composite material in an overwrap configuration (the layer therefore being designated the “bonding layer”), or to be the outer layer of a protected wire or cable construction.

In an embodiment of the present invention, composite 10 has an overall thickness of less than about 40 μm. Advantageously, very thin composites can be prepared in accordance with the present invention excellent electrical insulation properties. In an embodiment of the present invention, composite 10 has an overall thickness of less than about 30 μM, and in another embodiment, composite 10 has an overall thickness of less than about 20 μm. Dielectric composites having a lower overall thickness are particularly advantageous for use in aircraft and the aerospace industry due to the lighter weight associated with this product.

In an embodiment of the present invention, the first fluoropolymer layer and the second fluoropolymer layer independently each have a thickness of less than 10 μm. In another embodiment the first fluoropolymer layer and the second fluoropolymer layer independently each have a thickness of from about 2 to about 8 μm.

The composite of the present invention has as a central or core layer a polyimide film. The polyimide film is produced in the process described hereinafter or commercially available from KANEKA Texas Corporation as Apical AV, Apical NP and from Dupont as Kapton series such as Kapton V or Kapton E in a number of different grades.

Conventional thinking in the art has been that the polyimide film provides the properties of mechanical toughness and dielectric strength for dielectric composites for wrapping wire or cable. It has surprisingly been found that the properly selected fluoropolymer layers significantly impact the electrical insulation properties, particularly in mechanical toughness of the overall composite. This discovery permits the use of differing grades and thinner layers of polyimide film than were previously thought to be appropriate for use in high demand applications, such as aerospace environments. Generally, the polyimide layer should be thick enough to provide electrical insulation properties and structural strength. However, the polyimide layer generally must also be thin enough to be flexible and easily (and closely) molded to the article to be wrapped.

For these conflicting reasons, the polyimide layer in the conventional dielectric composite was limited from about 25 μm to about 30 μm, whereas the present invention permits additional use of thinner polyimide layer by selection of fluoropolymer. Specifically, from about 10 μm to about 25 μm, more specifically from about 12 μm to about 20 μm of the polyimide layer is permitted by the present invention. In an embodiment of the present invention, the polyimide layer is an ultrathin film having a thickness of less than 15 μm. In an embodiment of the present invention, the polyimide layer has a thickness of from about 10 μl to about 15 μm.

In particular, it was thought that the polyimide layer must have a sufficiently high modulus to provide the desired abrasion resistance to provide the mechanical toughness and dielectric strength for dielectric composites for wrapping wire or cable. Surprisingly, the present invention permits use of polyimide materials having a lower modulus than previously thought possible, thereby increasing choices of product components suitable for use, and potentially reducing cost of the overall product. In an embodiment of the invention, the polyimide layer has a modulus that is less than 650 kpsi (modulus being evaluated under ASTM D-2176). In another embodiment, the polyimide layer has a modulus that is less than 500 kpsi.

The polyimide layer is generally derived from a polyamic acid precursor. In general, the polyamic acid is prepared by dissolving substantially equimolar amounts of an aromatic acid dianhydride and an aromatic diamine in an organic solvent and stirring the resulting solution at a controlled temperature until the polymerization of the acid dianhydride and the diamine is completed. The polyamic acid precursor can also comprise conventional (or non-conventional) catalysts and/or dehydrating agent(s).

The polyamic acid of the present invention can be polymerized by any known methods. Particularly, the following polymerization methods are preferable.

(1) A method in which aromatic diamine is dissolved in an organic polar solvent and reacted therein with essentially an equimolar amount of aromatic tetracarboxylic dianhydride for polymerization.

(2) A method in which an excess molar amount of aromatic tetracarboxylic dianhydride is reacted with an aromatic diamine compound in an organic polar solvent so as to obtain a pre-polymer having acid anhydride groups at the both ends. Subsequent polymerization is carried out using the aromatic diamine compound such that the aromatic tetracarboxylic dianhydride becomes essentially equimolar with the aromatic diamine compound in all steps of production.

(3) A method in which aromatic tetracarboxylic dianhydride is reacted with an excess molar amount of an aromatic diamine compound in an organic polar solvent so as to obtain a pre-polymer having amino groups at the both ends. Subsequent polymerization is carried out by adding an aromatic diamine compound in the pre-polymer and using the aromatic tetracarboxylic dianhydride so that the aromatic tetracarboxylic dianhydride becomes essentially equimolar with the aromatic diamine compound.

(4) A method in which aromatic tetracarboxylic dianhydride is dissolved and/or dispersed in an organic polar solvent and is polymerized using an aromatic diamine compound of an equimolar amount.

(5) A method in which polymerization is carried out by a reaction of a mixture of equimolar amounts of aromatic tetracarboxylic acid dianhydride and an aromatic diamine compound in an organic polar solvent.

The following describes materials used to produce the precursor of polyimide, i.e., the polyamic acid of the present invention.

Examples of acid anhydrides used to produce the polyamic acid include: pyromellitic dianhydride; 2,3,6,7-naphthalene tetracarboxylic dianhydride; 3,3′,4,4′-biphenyl tetracarboxylic dianhydride; 1,2,5,6-naphthalene tetracarboxylic dianhydride; 2,2′,3,3′-biphenyl tetracarboxylic dianhydride; 3,3′,4,4′-benzophenone tetracarboxylic dianhydride; 2,2-bis(3,4-dicarboxyphenyl)propane dianhydride; 3,4,9,10-perylene tetracarboxylic dianhydride; bis(3,4-dicarboxyphenyl) propane dianhydride; 1,1-bis(2,3-dicarboxypheyl)ethane dianhydride; 1,1-bis(3,4-dicarboxyphenyl)ethane dianhydride; bis(2,3-dicarboxyphenyl)m-ethane dianhydride; bis(3,4-dicarboxyphenyl)ethane dianhydride; oxydiphthalic dianhydride; bis(3,4-dicarboxyphenyl)sulfone dianhydride; p-phenylenebis(trimellitic acid monoester anhydride; ethylene bis(trimellitic acid monoester anhydride; bisphenol A bis(trimellitic acid monoester anhydride; and their analogues. These compounds can be suitably used either individually or in a mixture of any proportions.

Examples of diamines that can be suitably used to produce the precursor of polyimide, i.e., the polyamic acid of the present invention, include: 4,4′-diaminophenylpropane; 4,4′-diaminophenylmethane; benzidine; 3,3′-dichlorobenzidine; 4,4′-diaminodiphenyl sulfide; 3,3′-diaminodiphenylsulfone; 4,4′-diaminodiphenylsulfone; 4,4′-diaminodiphenylether; 3,3′-diaminodiphenylether; 3,4′-diaminodiphenylether; 1,5-diaminonaphthalene; 4,4′-diaminodiphenyldiethylsilane; 4,4′-diaminodiphenylsilane; 4,4′-diaminodiphenyl ethylphosphine oxide; 4,4′-diaminodiphenyl N-methylamine; 4,4′-diaminodiphenyl N-phenylamine; 1,4-diaminobenzene(p-phenylenediamine); 1,3-diaminobenzene; 1,2-diaminobenzene, and their analogues. These compounds can be suitably used either individually or in a mixture of any proportions.

In order to obtain a flexible and easily molded film, it is preferable to use acid dianhydride or diamine starting materials that contain functionalities that provide a flexible structure in the ultimate polymer. The flexible structure-providing starting materials are compounds that contain functionalities such as, for example, an ether group, a sulfone group, a ketone group, or sulfide group. These monomers provide the polyimide layer with a low modulus. It was thought that the polyimide layer must have a sufficiently high modulus to provide the desired abrasion resistance to provide the mechanical toughness and dielectric strength for dielectric composites for wrapping wire or cable. The present invention permits use of these flexible structure-containing monomers with achievement of a good balance between the flexibility and the abrasion resistance.

In another aspect of the present invention, the monomers PMDA, ODA and PDA are noted in particular to be low-cost materials. Use of these materials is particularly advantageous from a cost standpoint. A polyimide film made only from PMDA, ODA and PDA monomers, and in particular only from PMDA and ODA monomers is a particularly preferred polyimide component for dielectric composites of the present invention. However, these monomers do not provide a film with high modulus or, in certain applications, high mechanical strength. In the absence of the present invention, it was thought that a dielectric composite comprising this polyimide film would not have sufficient abrasion resistance property. Surprisingly, the invention permits the use of inexpensive polyimide starting materials to prepare a dielectric composite that exhibits excellent performance properties.

In terms of easy polymerization, the preferable combination of the acid dianhydrides and the diamines is pyromellitic dianhydride and diaminodiphenylether.

Another preferable combination is pyromellitic dianhydride and diaminodiphenylether and p-phenylenediamine. In this combination, the molar ratio of diaminodiphenylether to p-phenylenediamine is 50/50 to 100/0, preferably 70/30 to 100/0.

The solvents that are preferably used for the synthesis of the polyamic acid are amide-family solvents, examples of which include N,N-dimethylformamide; N,N-dimethylacetoamide; and N-methyl-2-pyrrolidone. Among these compounds, it is preferable to use N,N-dimethylformamide and N,N-dimethylacetoamide either individually or in a mixture of any proportions.

A polyamic acid solution is usually obtained in a concentration of 5 wt % to 35 wt %, or more preferably 10 wt % to 30 wt %. With a concentration of polyamic acid solution in these ranges, a preferred molecular weight and a preferred solution viscosity can be obtained.

The polyimide is obtained by imidizing its precursor polyamic acid, which is carried out either by thermal curing or chemical curing. The thermal curing is a method in which the imidization reaction proceeds only by heating, without any action of a dehydrating agent or an imidizing catalyst, etc. The polyamic acid is completely converted into polyimides by heat treatment according to a known process, in which, in a heating furnace, heating is performed stepwise and successively, and finally, at high temperatures for a short period of time. Preferably, at the initial stage of the treatment in the heating furnace, the temperature is set at about 150° C. to 350° C. to remove the remaining solvent, etc., by drying; the temperature is gradually or stepwise increased; and finally, in the high-temperature heating furnace at a temperature of about 450° C. to 620° C., heating is performed for 15 to 400 seconds. The chemical curing is a method in which an organic solvent solution of polyamic acid is acted upon by a dehydrating agent as represented by acid anhydrides such as acetic acid anhydride, and by an imidizing catalyst as represented by tertiary amines such as isoquinoline, β-picoline, and pyridine. The chemical curing may be performed with the thermal curing. Reaction conditions of imidization vary depending on the type of polyamic acid, the thickness of the film, or the selected method of curing, which may be thermal curing and/or chemical curing.

In a producing process of the polyimide film of the present invention, a step of producing a partially cured and/or partially dried polyamic acid film (gel film) is carried out by a known method. Namely, the organic solvent solution of polyamic acid adjusted in the foregoing manner is cast or coated on a support such as a glass plate, an endless stainless-steel belt, or a stainless-steel drum, so as to carry out imidization by heating. Alternatively, the dehydrating agent and the catalyst are mixed in a polyamic acid solution at a low temperature and the polyamic acid solution is cast in the form of a film on a support and heated to activate the dehydrating agent and the imidizing catalyst. By this thermal imidization or chemical imidization, a partially cured self-supporting polyamic acid film (gel film) is produced. Note that, as the term is used herein, “partially cured” or “partially dried” means partial imidization of the amide bonds initially present in the polyamic acid solution, or partial evaporation or drying of a volatile component initially present in the initial polyamic acid solution. These terms do not mean partial curing or partial drying with respect to the entire surface of the film.

The gel film is in an intermediate stage of curing from the polyamic acid to the polyimide and is self-supporting.

Thereafter, the both ends in the transverse direction of the gel film are grasped using pins or clips, etc., before the gel film is carried to a heating furnace, where the gel film is dried to remove a volatile component such as an organic solvent and then subjected to a heat treatment to obtain the polyimide film.

Any conventional or non-conventional method for manufacturing polyimide film can be used to manufacture the polyimide layer of the present invention.

Examples of materials and methods are described in U.S. Pat. Nos. 3,616,177; 5,066,770; 5,070,181; and 5,081,229; which are all hereby incorporated by reference for all purposes.

Selection of the fluoropolymer layer materials and characteristics has been found to be important aspects of the present invention. Specifically, the first and second fluoropolymer layers independently comprise at least about 55% of poly(tetrafluoroethylene-co-perfluoro[alkyl vinyl ether]) or “PFA.” PFA is commercially available from Dupont as DuPont™ Teflon® PFA and from 3M Company as Dyneon™ PFA resin products in a number of different grades.

It has been discovered that the fluoropolymer coatings on the polyimide layer beneficially contain higher amounts of PFA in the coating. Thus, in an embodiment of the present invention, the first fluoropolymer layer and the second fluoropolymer layer independently comprise at least about 80% PFA. In other embodiments, the layers independently comprise at least about 90% PFA or at least about 95% PFA. In a particularly preferred embodiment, the first fluoropolymer layer and the second fluoropolymer layer comprise about 100% PFA.

The fluoropolymer layer may optionally comprise a polymer in addition to PFA that is not a fluoropolymer. Preferably, the fluoropolymer layer may comprise a polymer in addition to PFA that is a fluoropolymer. The additional polymer preferably is selected from FEP, PPVE, PTFE, chlorotrifluoroethylene polymer (CTFE), tetrafluoroethylene chlorotrifluoroethylene copolymer (TFE/CTFE), ethylene chlorotrifluoroethylene copolymer (ECTFE), poly(ethylene-co-tetrafluoroethylene) (ETFE), polyvinylidene fluoride (PVDF), and combinations thereof. Most preferably, if present, the additional polymer is selected from FEP, PTFE or combinations thereof.

Conventional thinking in the art suggested that when a fluoropolymer coating was used in the insulating wire or cable wrap environment, it was necessary to incorporate PTFE as part of the construction. It has surprisingly been found that in an embodiment of the present invention, a dielectric composite exhibiting excellent performance can be prepared even without using PTFE. Thus, an embodiment of the present invention contemplates a dielectric composite construction that is substantially free of PTFE.

In a preferred embodiment of the present invention, the composite is symmetrical, meaning that the first fluoropolymer layer and the second fluoropolymer layer have the same chemical make-up. This embodiment provides substantial benefit in ease of production, reduction of the number of materials needed to stock in the factory, ease of use, and demonstrated performance of the product.

The dielectric composite construction of the present invention may be prepared by any suitable techniques as will now be apparent to the skilled artisan. For example, the polyimide layer may in one embodiment be laminated with the first and second fluoropolymer layers by a lamination technique such as a transfer lamination. Alternatively the polyimide layer may be coated with a coating material that cures in place to form the first and second fluoropolymer layers. Optionally, the major surfaces of the polyimide layer are prepared in advance to enhance adhesion of the fluoropolymer layers by surface treatment. Examples of surface treatments include corona treatment, plasma treatment under atmospheric pressure, plasma treatment under reduced pressure, treatment with coupling agents like silanes and titanates, sandblasting, alkali-treatment, and acid-treatment. In an embodiment of the present invention, the major surfaces of the polyimide layers are primed with an adhesion promoter material. Optionally, a priming layer may be used, such as a minor layer of FEP and/or of PTFE. While intermediate layers for enhancing bonding or to obtain other advantageous properties are contemplated, the external layers of the dielectric composite construction are the first and second fluoropolymer layers as described herein. Preferably, the present dielectric composite construction consists of only the three layers as described herein, with no identifiable additional continuous layers being present in the composite. This simple three layer construction has been found to provide excellent performance properties, and additionally may be made in a straightforward process and is easy to use.

The dielectric composite of the present invention may be applied to electronic material such as wire or cable in any manner suitable to provide protection of the electronic material in ordinary operation. A dielectric composite in accordance with the present invention can be used as all or part of a housing for one or more conductive wires or cables, such as a wire or cable wrap or as a housing component of a “flat wire” as commonly used in aerospace wiring applications. Preferably, the dielectric composite is provided in the form of a tape that is wound around the wire or cable and then heated to bond the wrap to itself and to the wire or cable or the like.

### EXAMPLES

Representative embodiments of the present invention will now be described with reference to the following examples that illustrate the principles and practice of the present invention.

(Cut-Through Measurement)

The wires were tested for dynamic cut-through resistance using the method described in the BS EN 3475-501:2006.

(Abrasion Measurement)

The wires were tested for Scrape abrasion using the method described in the BS EN 3475-503:2002.

### Synthesis Example 1

Polyamic acid was synthesized from a 1:1 mole ratio of pyromellitic dianhydride:4,4′-diaminodiphenylether. A DMF solution containing 18.5 wt % of the polyamic acid was prepared and mixed and stirred with 55 wt % of a curing agent containing acetic anhydride, isoquinoline, and DMF. The mixture was adjusted so that the acetic anhydride and isoquinoline were 3.5 mole equivalent and 0.4 mole equivalent, respectively, with respect to the amic acid group of the polyamic acid. The mixture was then cast through a T slit die onto a rotary stainless-steel endless belt, and the resin film so cast was heated in hot air at 130° C. for 80 seconds to prepare a self-supporting gel film (polyimide precursor film). The gel film was then detached from the endless belt and, with its end portions fastened on a tenter frame, conveyed to a heating furnace maintained at 300° C. for 20 seconds, 450° C. for 20 seconds and 500° C. for 30 seconds to produce a polyimide film with a thickness of 0.75 mil (19.05 micron) and a modulus of 420 kpsi.

### Synthesis Example 2

Polyamic acid was synthesized from a 4:3:1 mole ratio of pyromellitic dianhydride, 4,4′-diaminodiphenylether, and p-phenylenediamine. A DMF solution containing 18.5 wt % of the polyamic acid was prepared and mixed and stirred with 60 wt % of a curing agent containing acetic anhydride, isoquinoline, and DMF. The mixture was adjusted so that the acetic anhydride and isoquinoline were 2.0 mole equivalent and 0.4 mole equivalent, respectively, with respect to the amic acid group of the polyamic acid. The mixture was then cast through a T slit die onto a rotary stainless-steel endless belt, and the resin film so cast was heated in hot air at 140° C. for 90 seconds to prepare a self-supporting gel film (polyimide precursor film). The gel film was then detached from the endless belt and, with its end portions fastened on a tenter frame, conveyed to a heating furnace maintained at 200° C. for 12 seconds, 300° C. for 12 seconds, 370° C. for 10 seconds and 550° C. for 20 seconds to produce a polyimide film with a thickness of 0.72 mil (18.29 micron) and a modulus of 600 kpsi.

### Synthesis Example 3

The polyimide film with a thickness of 0.77 mil (19.56 micron) and a modulus of 600 kpsi was similarly obtained from the method described in Synthesis Example 2.

### Example 1

The polyimide film obtained from Synthesis Example 1 was coated with an aqueous dispersion of PFA, such that a 0.1 mil (2.54 micron) resin coating was obtained containing the PFA on both faces of the polyimide film. These coatings were applied in a conventional dip coating tower.

### Examples 2 Through 3

The dielectric composite and the wire were prepared as in EXAMPLE 1 but with the polyimide films of Synthesis Examples 2 and 3, respectively. The properties of the composite obtained when applied to wires of the indicated gauges are shown in Table 1.

### Comparative Example 4

The dielectric composite and the wire were prepared as in EXAMPLE 1 but with a different type of fluoropolymer, FEP. The properties of the composite obtained when applied to wires of the indicated gauges are shown in Table 2.

TABLE 1

| | | | | | | Average | |
|---|---|---|---|---|---|---|---|
| | | | | Average | | cut- | |
| | | Fluoro | | abrasion | # of | through | # of |
| | Polyimide | polymer | | value | data | value | data |
| Example | film | layer | Wire gauge | (cycles) | points | (N) | points |
| 1a | Synthesis | PFA | 20 | 309 | 6 | 161.7 | 14 |
| | Example 1 | (0.1 mil) | | | | | |
| 1b | Synthesis | PFA | 24 | 129.6 | 9 | 94 | 16 |
| | Example 1 | (0.1 mil) | | | | | |
| 2a | Synthesis | PFA | 20 | 482 | — | 136 | — |
| | Example 2 | (0.1 mil) | | | | | |
| 2b | Synthesis | PFA | 24 | Ranged | — | Ranged | — |
| | Example 2 | (0.1 mil) | | 170-223 | | 102-112 | |
| 3a | Synthesis | PFA | 20 | 383 | 12 | 153.3 | 16 |
| | Example 3 | (0.1 mil) | | | | | |

TABLE 2

| | | | | | | Average | |
|---|---|---|---|---|---|---|---|
| | | | | Average | | cut- | |
| | | Fluoro | | abrasion | # of | through | |
| Comparative | Polyimide | polymer | Wire | value | data | value | # of data |
| Example | film | layer | gauge | (cycles) | points | (N) | points |
| 4a | Synthesis | FEP | 20 | <100 | — | <140 | — |
| (Comparative) | Example 1 | (0.1 mil) | | | | | |
| 4b | Synthesis | FEP | 24 | <100 | — | <85 | — |
| (Comparative) | Example 1 | (0.1 mil) | | | | | |

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A dielectric composite useful for wrapping wire or cable or for supporting electronic circuitry, the composite comprising:
a) a polyimide layer having first and second major surfaces;
b) a first fluoropolymer layer on the first major surface on the polyimide layer, said first fluoropolymer layer comprising at least about 55% PFA; and
c) a second fluoropolymer layer on the second major surface on the polyimide layer, said second fluoropolymer layer comprising at least about 55% PFA.

2. The dielectric composite of claim 1, wherein the first fluoropolymer layer and the second fluoropolymer layer have the same chemical make-up.

3. The dielectric composite of claim 1, wherein the polyimide film has a modulus that is less than 650 kpsi.

4. The dielectric composite of claim 1, wherein the composite has an overall thickness of less than about 30 μm.

5. The dielectric composite of claim 1, wherein the composite has an overall thickness of less than about 20 μm.

6. The dielectric composite of claim 1, wherein the first fluoropolymer layer and the second fluoropolymer layer independently comprise at least about 80% PFA.

7. The dielectric composite of claim 1, wherein the first fluoropolymer layer and the second fluoropolymer layer independently comprise at least about 90% PFA.

8. The dielectric composite of claim 1, wherein the first fluoropolymer layer and the second fluoropolymer layer independently comprise at least about 95% PFA.

9. The dielectric composite of claim 1, wherein the first fluoropolymer layer and the second fluoropolymer layer comprise about 100% PFA.

10. The dielectric composite of claim 1, wherein the first fluoropolymer layer and the second fluoropolymer layer independently each have a thickness of less than 10 μm.

11. The dielectric composite of claim 1, wherein the first fluoropolymer layer and the second fluoropolymer layer independently each have a thickness of from about 4 to about 8 μm.

12. The dielectric composite of claim 1, wherein the polyimide layer has a thickness of from about 10 to about 25 μm.

13. The dielectric composite of claim 1, wherein the polyimide layer is prepared from a polyamic acid that is the reaction product of pyromellitic dianhydride and diaminodiphenylether and p-phenylenediamine, wherein the molar ratio of diaminodiphenylether to p-phenylenediamine is from about 50/50 to about 100/0.

14. The dielectric composite of claim 13, wherein the molar ratio of diaminodiphenylether to p-phenylenediamine is from about 70/30 to about 100/0.

15. The dielectric composite of claim 1, wherein the dielectric composite construction is substantially free of PTFE.

16. The dielectric composite of claim 1, wherein the dielectric composite construction consists of only the three layers of the polyimide layer and the first and second fluoropolymer layers, with no identifiable additional continuous layers being present in the composite.

17. A protected wire or cable, wherein the wire or cable is wrapped with the dielectric composite of claim 1.

18. A method for wrapping wire or cable or for supporting electronic circuitry, comprising
a) providing a wire or cable, and
b) wrapping the wire or cable with the dielectric composite of claim 1 in a manner to provide electrical insulative protection.
